(19) United States
(12) Patent Application Publication
(10) Pub. No.: US 2026/0186696 A1
(43) Pub. Date: Jul. 2, 2026

(54) CONTROLLER, MEMORY MODULE INCLUDING CONTROLLER, AND OPERATING METHOD OF MEMORY MODULE

(71) Applicant: Samsung Electronics Co., Ltd., Suwon-si (KR)

(72) Inventors: KYUNG-SAN KIM, Suwon-si (KR); CHIHUN SONG, Suwon-si (KR); JONG HOON KIM, Suwon-si (KR); SUNGJOO PARK, Suwon-si (KR); JININ SO, Suwon-si (KR); JAE-IN SONG, Suwon-si (KR); TAEKSANG SONG, Suwon-si (KR); JEONGHYEON CHO, Suwon-si (KR)

(21) Appl. No.: 19/433,635

(22) Filed: Dec. 26, 2025

(30) Foreign Application Priority Data
Dec. 30, 2024 (KR) 10-2024-0199841
Apr. 23, 2025 (KR) 10-2025-0053320

(51) Int. Cl. G06F 3/06

(52) U.S. Cl. CPC G06F 3/0655; G06F 3/0619; G06F 3/0679

(57) ABSTRACT

A memory module includes a memory device that includes a memory cell array including a fault block in which a fault cell is included and a remap block for replacing the fault block, and a controller that communicates with a host device through a compute express link (CXL) interface and to control the memory device. The controller may redundantly store recovery information including a fault flag and a remap address corresponding to the remap block in the memory device, may read data corresponding to a target address from the memory device, based on receiving a first, may identify whether the target address is the fault address, based on the data corresponding to the target address, and may generate a second request including the remap address based on the data corresponding to the target address, when it is determined that the target address is the fault address.

### CROSS-REFERENCE TO RELATED APPLICATIONS

This application claims priority under 35 U.S.C. § 119 to Korean Patent Application Nos. 10-2024-0199841 filed on Dec. 30, 2024, and 10-2025-0053320 filed on Apr. 23, 2025, in the Korean Intellectual Property Office, the disclosures of which are incorporated by reference herein in their entireties.

### TECHNICAL FIELD

The present disclosure relates to a controller, a memory module including the controller, and an operating method of the memory module, and more particularly, relate to a controller based on a compute express link (CXL) interface, a memory module including the controller, and an operating method of the memory module.

### BACKGROUND

Nowadays, application services based on machine learning or artificial intelligence requiring large-scale data processing are rapidly growing and advancing. Accordingly, the demand on memory resources, which often acts as a bottleneck in the performance of such services (e.g., learning or inference), is increasing rapidly.

A compute express link (CXL) interface-based interconnect technology has emerged to provide efficient scalability and composability of memory resources.

### SUMMARY

Implementations of the present disclosure provide a CXL device capable of recovering a fault of a memory device more efficiently, a memory module including the same, and an operating method of the memory module.

According to some implementations, a memory module may include a memory device that includes a memory cell array including a fault block in which a fault cell is included and a remap block for replacing the fault block, and a controller configured to communicate with a host device through a compute express link (CXL) interface and control the memory device. The controller may redundantly store recovery information including a fault flag and a remap address corresponding to the remap block in the memory device based on a fault address corresponding to the fault block, may read data corresponding to a target address from the memory device, based on receiving a first request including the target address from the host device, may identify whether the target address is the fault address, based on the data corresponding to the target address, and may generate a second request including the remap address based on the data corresponding to the target address, when it is determined that the target address is the fault address.

In addition, the memory module may further include a nonvolatile memory that stores a fault address list including a plurality of fault addresses respectively corresponding to a plurality of fault blocks included in the memory cell array, and a start address of a remap region being a region of the memory cell array including a plurality of remap blocks. During an initialization operation, the controller may map different remap addresses to the plurality of fault addresses based on the start address of the remap region and may redundantly store relevant recovery information including a relevant remap address and the fault flag based on each of the plurality of fault addresses.

Also, the controller may store the fault flag in each of a plurality of first regions of the fault block and store the remap address in each of a plurality of second regions of the fault block, may apply a majority voting manner to data corresponding to the plurality of first regions from among the data corresponding to the target address, may obtain the remap address by applying the majority voting manner to data corresponding to the plurality of second regions from among the data corresponding to the target address, when the fault flag is obtained as a result of applying the majority voting manner, and may generate a second request including the obtained remap address.

Furthermore, the fault flag may include a hash value of the fault address or a preset constant value.

Besides, the controller may store the fault flag in each of some regions of an error correction code (ECC) block corresponding to the fault block and store the remap address in each of a plurality of regions of the fault block, may check whether data corresponding to the some regions of the ECC bock from among the data corresponding to the target address correspond to the fault flag, may obtain the remap address by applying a majority voting manner to data corresponding to the plurality of regions of the fault block from among the data corresponding to the target address, when the data corresponding to the some regions correspond to the fault flag, and may generate a second request including the obtained remap address.

Moreover, the some regions of the ECC block may be regions corresponding to bits not used for an ECC function from among bits stored in the ECC block.

In addition, the first request may be a first read request including the target address, and the controller may identify the target address as the fault address and generate a second read request including the remap address, when the fault flag is identified from the data corresponding to the target address, may read data corresponding to the remap address from the memory device based on the second read request, and may provide the data corresponding to the remap address to the host device.

Also, when the fault flag is not identified from the data corresponding to the target address, the controller may provide the data corresponding to the target address to the host device.

Furthermore, the controller may include a bloom filter that outputs a given value based on the fault address list when an input address is included in the plurality of fault addresses.

Besides, the first request may be a first write request including the target address, and the controller may input the target address to the bloom filter in response to that the first write request is received, may read the data corresponding to the target address from the memory device, when the given value is output from the bloom filter, and may write data in a region of the memory cell array, which corresponds to the target address, based on the first write request, when the given value is not output from the bloom filter.

Moreover, the controller may identify the target address as the fault address and generate a second write request including the remap address, when the fault flag is identified from the data corresponding to the target address, and may write data in a region of the memory cell array, which corresponds to the remap address, based on the second write request.

In addition, when the fault flag is not identified from the data corresponding to the target address, the controller may write the data in the region of the memory cell array, which corresponds to the target address, based on the first write request.

Also, the memory cell array may include a first fault block, and a first remap block for replacing the first fault block, and the controller may include a cache memory that stores mapping information in which a first fault address corresponding to the first fault block and a first remap address corresponding to the first remap block are mapped.

Furthermore, the controller may identify whether the target address corresponds to the first fault address, based on the mapping information stored in the cache memory, when a first request including the target address is received, and may generate a third request including the first remap address using the mapping information stored in the cache memory, when an identification result based on the mapping information indicates that the target address corresponds to the first fault address.

According to some implementations of the present disclosure, a compute express link (CXL) device may include a host interface that communicates with a host device using a CXL protocol, and a memory controller that controls a memory device and processes a request of the host interface received through the host interface. The memory controller may include a repair engine for replacing a fault block of the memory device with a remap block, and the repair engine may redundantly store recovery information including a fault flag and a remap address corresponding to the remap block in the memory device based on a fault address corresponding to the fault block, may read data corresponding to a target address from the memory device, based on receiving a first request including the target address from the host device, may identify whether the target address is the fault address, based on the data corresponding to the target address, and may generate a second request including the remap address based on the data corresponding to the target address, when it is determined that the target address is the fault address.

In addition, the CXL device may further include a nonvolatile memory that stores a fault address list including a plurality of fault addresses respectively corresponding to a plurality of fault blocks included in the memory device, and a start address of a remap region being a region of the memory device including a plurality of remap blocks. During an initialization operation, the repair engine may map different remap addresses to the plurality of fault addresses based on the start address of the remap region and may redundantly store relevant recovery information including a relevant remap address and the fault flag based on each of the plurality of fault addresses.

Also, the repair engine may store the fault flag in each of a plurality of first regions of the fault block and store the remap address in each of a plurality of second regions of the fault block, may apply a majority voting manner to data corresponding to the plurality of first regions from among the data corresponding to the target address, may obtain the remap address by applying the majority voting manner to data corresponding to the plurality of second regions from among the data corresponding to the target address, when the fault flag is obtained as a result of applying the majority voting manner, and may generate a second request including the obtained remap address.

Furthermore, the repair engine may store the fault flag in each of some regions of an error correction code (ECC) block corresponding to the fault block, may store the remap address in each of a plurality of regions of the fault block, may check whether data corresponding to the some regions of the ECC bock from among the data corresponding to the target address correspond to the fault flag, may obtain the remap address by applying a majority voting manner to data corresponding to the plurality of regions of the fault block from among the data corresponding to the target address, when the data corresponding to the some regions correspond to the fault flag, and may generate a second request including the obtained remap address.

According to some implementations of the present disclosure, a memory module may include a memory device that includes a first fault block, a second fault block, a first remap block corresponding to the first fault block, and a second remap block corresponding to the second fault block, and a controller that includes a cache memory, communicates with a host device through a compute express link (CXL) interface, and controls the memory device. The controller may store mapping information, in which a first fault address corresponding to the first fault block and a first remap address corresponding to the first remap block are mapped, in the cache memory, may redundantly store recovery information including a fault flag and a second remap address corresponding to the second remap block in the memory device based on a second fault address corresponding to the second fault block, and may generate a second request including the first remap address based on the mapping information stored in the cache memory, when a first request including the first fault address is received from the host device.

In addition, the controller may read data corresponding to the second fault address from the memory device, when a third request including the second fault address is received from the host device, may obtain the second remap address from the data corresponding to the second fault address through a majority voting manner, and may generate a fourth request including the obtained second remap address.

### BRIEF DESCRIPTION OF THE DRAWINGS

The above and other objects and features of the present disclosure will become apparent by describing in detail implementations thereof with reference to the accompanying drawings.

FIG. 1 is a block diagram of a memory module according to some implementations of the present disclosure.

FIG. 2 is a diagram illustrating an example of a configuration of a memory cell array according to some implementations of the present disclosure.

FIG. 3 is a block diagram illustrating a configuration of a memory module according to some implementations of the present disclosure.

FIG. 4 is a diagram for describing a method of storing recovery information, according to some implementations of the present disclosure.

FIG. 5 is a diagram for describing a method of obtaining a remap address, according to some implementations of the present disclosure.

FIG. 6 is a diagram for describing a method of storing recovery information, according to some implementations of the present disclosure.

FIG. 7 is a diagram for describing a method of obtaining a remap address, according to some implementations of the present disclosure.

FIG. 8 is a flowchart illustrating an operating method of a memory module according to some implementations of the present disclosure.

FIG. 9 is a flowchart illustrating an operating method of a memory module according to some implementations of the present disclosure.

FIG. 10 is a flowchart illustrating an operating method of a memory module according to some implementations of the present disclosure.

FIG. 11 is a flowchart illustrating an operating method of a memory module according to some implementations of the present disclosure.

FIG. 12 is a flowchart illustrating an operating method of a repair engine according to some implementations of the present disclosure.

FIG. 13 is a diagram illustrating an order in which requests of different addresses are processed, according to some implementations of the present disclosure.

FIG. 14 is a diagram illustrating an order in which requests of the same address are processed, according to some implementations of the present disclosure.

### DETAILED DESCRIPTION

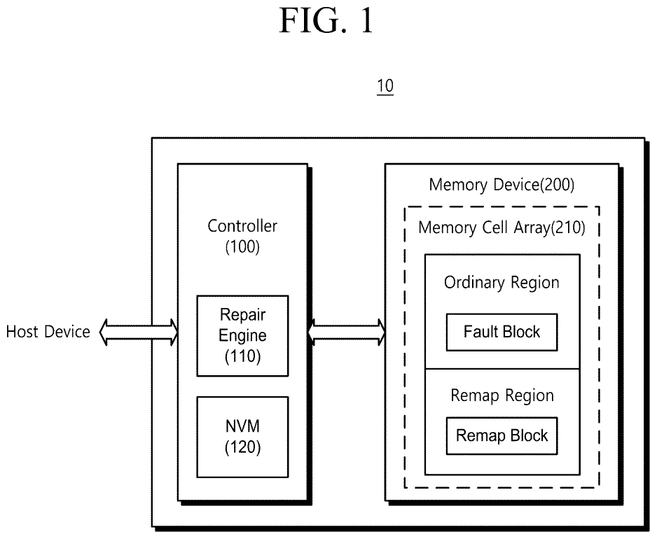

FIG. 1 is a block diagram of a memory module according to some implementations of the present disclosure.

A memory module 10 according to some implementations of the present disclosure may automatically recover a hardware fault of a memory device 200 by remapping a fault address corresponding to a fault block to a remap address corresponding to a normal block. In this case, the fault block and the normal block may be memory blocks included in the memory device 200 and may have the size (e.g., 64 bytes) of a cache line. However, the present disclosure is not limited thereto.

To this end, the memory module 10 according to some implementations of the present disclosure may redundantly store recovery information for remapping the fault address to the remap address in the memory device 200 based on the fault address. In this case, the recovery information may include the fault flag for identifying whether an input address is the fault address, and the remap address.

According to the above description, when a request including the fault address is received, the memory module 10 according to some implementations of the present disclosure may read a plurality of recovery information from the memory device 200 based on the fault address and may remap the fault address to the remap address in real time using the plurality of recovery information.

Because the fault address corresponds to the fault block, data stored in the fault block may include an error. However, the memory module 10 according to some implementations of the present disclosure may redundantly store the recovery information and may obtain the remap address from the plurality of recovery information, through a majority voting manner. Accordingly, the reliability of the obtained remap address may be improved.

Also, because the memory module 10 according to some implementations of the present disclosure stores the recovery information using the fault block, there is no need to allocate a separate space of the memory device 200 to store the remap address.

Also, because the fault flag is capable of being stored in the fault block or an error correction code (ECC) block associated with the fault block based on the fault address, compared to the case where the remap address is stored in a separate space of the memory device 200 rather than the fault block, the number of times of the access to the memory device 200 for a remapping operation may decrease. According to the above description, the time required for the remapping operation may be reduced.

Also, the fault of the memory device 200 may be recovered in units of memory block, and the hardware fault of the memory device 200 may be flexibly recovered without being limited by the number of fault blocks or the address space.

Accordingly, according to some implementations of the present disclosure, the coverage in which the hardware fault of the memory device 200 is capable of being recovered may be significantly improved, and the memory module 10 may be configured using the memory device 200 with low quality.

The description will be given in detail with reference to FIG. 1. Referring to FIG. 1, the memory module 10 may include a controller 100 and the memory device 200. In FIG. 1, for convenience, the memory module 10 is illustrated as including one memory device 200. However, the present disclosure is not limited thereto. The memory module 10 may include a plurality of memory devices. In this case, each of the plurality of memory devices included in the memory module 10 may correspond to the memory device 200 illustrated in FIG. 1.

According to some implementations, the memory module 10 may be a CXL (compute express link) type 3 DRAM device. For example, the memory module 10 may be connected to a central processing unit (CPU), a graphic processing unit (GPU), an AI accelerator, a storage device, etc., of a host device based on the PCIe (Peripheral Component Interconnect Express) interface.

The controller 100 may control the memory device 200. For example, the controller 100 may control the memory device 200 depending on a request of a processor supporting various applications such as a server application, a personal computer (PC) application, and a mobile application.

The controller 100 may communicate with the host device including the processor through the CXL interface and may control the memory device 200 depending on the request of the processor. To this end, the controller 100 may support the CXL. io and CXL. mem protocols.

To control the memory device 200, the controller 100 may transmit a command and/or an address to the memory device 200. In this case, the command and/or the address may correspond to the request received from the host device or the request generated by the controller 100. Also, the controller 100 may transmit data to the memory device 200 or may receive data from the memory device 200. In this case, the data may be a code word (CW).

The memory device 200 may receive and store the code word from the controller 100 in response to a write request from the controller 100. Also, the memory device 200 may read the stored code word in response to a read request of the controller 100 and may transmit the read code word to the controller 100.

For example, the memory device 200 may be configured to receive a command and/or an address from the controller 100, access a region of a memory cell array 210, which is selected by the address, and perform an operation indicated by the command with respect to the selected region. In this case, the operation indicated by the command may be a write operation, a read operation, or a delete operation.

According to some implementations, the memory device 200 may include volatile memory cells. For example, the memory device 200 may include various DRAM devices such as a double data rate synchronous dynamic random access memory (DDR SDRAM), a DDR2 SDRAM, a DDR3 SDRAM, a DDR4 SDRAM, a DDR5 SDRAM, a DDR6 SDRAM, a low power double data rate (LPDDR) SDRAM, an LPDDR2 SDRAM, an LPDDR3 SDRAM, an LPDDR4 SDRAM, an LPDDR4X SDRAM, an LPDDR5 SDRAM, a graphics double data rate synchronous graphics random access memory (GDDR SGRAM), a GDDR2 SGRAM, a GDDR3 SGRAM, a GDDR4 SGRAM, a GDDR5 SGRAM, and a GDDR6 SGRAM.

Also, according to some implementations, the memory device 200 may be a stacked memory device, in which DRAM dies are stacked, such as a high bandwidth memory (HBM), an HBM2, or an HBM3.

Also, according to some implementations, the memory device 200 may include an SRAM device, a NAND flash memory device, a NOR flash memory device, an RRAM device, an FRAM device, a PRAM device, a TRAM device, an MRAM device, etc.

The memory device 200 may include the memory cell array 210. The memory cell array 210 may include a plurality of banks, Bank 1 to Bank n, each of which includes memory cells for storing data. For convenience of description, in the specification, it is assumed that each bank includes DRAM cells. However, this is provided as an example, and each of the plurality of banks, Bank 1 to Bank n, may be implemented to include any other volatile memory cells in addition to the DRAM cells. Also, the plurality of banks, Bank 1 to Bank n, may be implemented to include the same kind of memory cells or may be implemented to include different kinds of memory cells.

The memory cell array 210 may include a plurality of memory blocks. The plurality of memory blocks may include at least one fault block and a plurality of normal blocks. The fault block may be a memory block including at least one fault cell. In this case, the fault cell may occur during the process of manufacturing the memory device 200 or due to the aging of the memory device 200 over time. The normal block may be a memory block not including a fault cell. Each memory block may have the size of a cache line.

The memory cell array 210 may be divided into an ordinary region and a remap region. The ordinary region may be a region including at least one fault block and normal blocks. The remap region may be a region including remap blocks. The remap blocks may be normal blocks that are used for the purpose of replacing a fault block.

According to some implementations of the present disclosure, the fault block may be replaced with the remap block. To this end, the controller 100 may include a repair engine 110 for remapping a fault address to a remap address, and a nonvolatile memory 120. Herein, the fault address may be an address for accessing a fault block, and the remap address may be an address for accessing a remap block.

The nonvolatile memory 120 may store initial information for generating recovery information. The initial information may include a fault address list including a plurality of fault addresses respectively corresponding to a plurality of fault blocks included in the memory cell array 210, and a start address of the remap region, which is a region of the memory cell array 210 including a plurality of remap blocks. In this case, the fault address list may be obtained during the manufacturing process of the memory module 10 or after the manufacturing process, through a test operation in which given bit patterns are stored in and read from the memory device 200, and may be stored in the nonvolatile memory 120. However, the present disclosure is not limited thereto.

The repair engine 110 may redundantly store recovery information for recovering a fault block in the memory device 200 based on a fault address. The recovery information may include a fault flag and a remap address corresponding to a remap block.

For example, during the initialization operation of the memory module 10 or the controller 100, the repair engine 110 may load the initial information stored in the nonvolatile memory 120 and may redundantly store the recovery information in the memory device 200 based on the loaded initial information.

In detail, during the initialization operation, the repair engine 110 may map or allocate the plurality of fault addresses included in the fault address list to different remap addresses based on the start address of the remap region and may generate recovery information corresponding to each fault address. In this case, each recovery information may include a remap address mapped to the corresponding fault address and a fault flag. According to the above description, the repair engine 110 may redundantly store the recovery information corresponding to each fault address in the memory device 200 based on the corresponding fault address.

According to some implementations, based on a fault address, the repair engine 110 may store a fault flag in each of a plurality of first regions of a fault block and may store a remap address in each of a plurality of second regions of the fault block. According to some implementations, based on a fault address, the repair engine 110 may store a fault flag in each of some regions of an ECC block corresponding to a fault block and may store a remap address in each of a plurality of regions of the fault block. In this case, the ECC block may be a region of the memory device 200, in which parity data corresponding to data stored in the fault block is stored. Also, the some regions of the ECC block, in which the fault flag is stored, may be regions of the ECC block, in which the parity data are not stored. According to the above description, the recovery information may be redundantly stored in the memory device 200 based on the fault address.

Afterwards, when a request including the fault address is received from the host device, the repair engine 110 may remap the fault address to the remap address such that the received request is processed in a remap block. According to the above description, the fault block may be replaced with the remap block.

In detail, based on receiving a first request including a target address from the host device, the repair engine 110 may read data corresponding to the target address from the memory device 200. In this case, the data corresponding to the target address may include data stored in a target block corresponding to the target address, and data stored in an error correction code (ECC) block corresponding to the target block. ECC data for the data stored in the target block may be stored in the ECC block corresponding to the target block. Accordingly, the data corresponding to the target address may be code word data corresponding to the target address.

The repair engine 110 may identify whether the target address is the fault address, based on the data corresponding to the target address. When the target address is identified as the fault address, the repair engine 110 may generate a second request including the remap address based on the data corresponding to the target address.

According to some implementations, as described above, the fault flag may be redundantly stored in the plurality of first regions of the fault block, and the remap address may be redundantly stored in the plurality of second regions of the fault block. In this case, the repair engine 110 may apply the majority voting manner to data corresponding to the plurality of first regions from among the data corresponding to the target address. When the fault flag is obtained as a result of applying the majority voting manner, the repair engine 110 may obtain the remap address by applying the majority voting manner to data corresponding to the plurality of second regions from among the data corresponding to the target address, and may generate the second request including the obtained remap address.

According to some implementations, as described above, the fault flag may be redundantly stored in some regions of the ECC block corresponding to the fault block, and the remap address may be redundantly stored in a plurality of regions of the fault block. In this case, the repair engine 110 may check whether data corresponding to the some regions of the ECC block from among the data corresponding to the target address correspond to the fault flag. When a check result indicates that the data corresponds to the fault flag, the repair engine 110 may obtain the remap address by applying the majority voting manner to data corresponding to the plurality of regions of the fault block from among the data corresponding to the target address, and may generate the second request including the obtained remap address.

The controller 100 may transmit the command and the remap address to the memory device 200 such that the second request is processed in the remap block.

As described above, when a request including a fault address is received from the host device, the repair engine 110 may replace a fault block with a remap block by remapping the fault address to the remap address.

Accordingly, a CXL device capable of recovering a fault of a memory device more efficiently, a memory module including the same, and an operating method of the memory module may be provided.

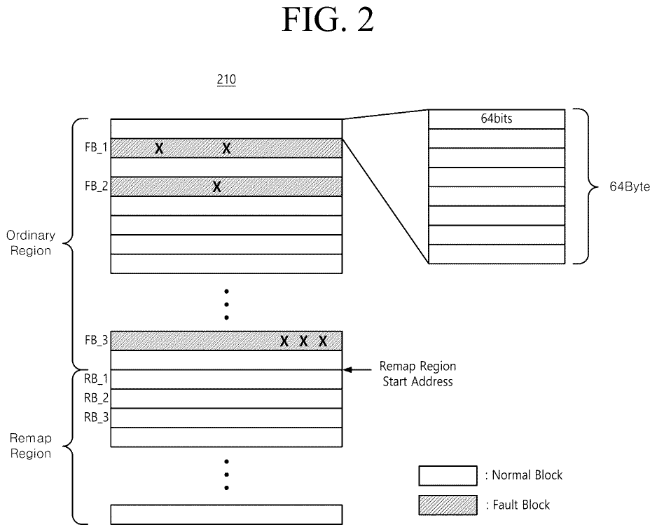

FIG. 2 is a diagram illustrating an example of a configuration of a memory cell array according to some implementations of the present disclosure. The memory cell array 210 of FIG. 2 may correspond to the memory cell array 210 of the memory device 200 of FIG. 1.

Referring to FIG. 2, the memory cell array 210 may include a plurality of memory blocks. Each of the plurality of memory blocks may have a size (e.g., 64 bytes) of a cache line. Assuming that the host device and the memory module 10 constitute a system that uses a 64-bit address, eight addresses may be redundantly stored in one memory block.

The memory cell array 210 may be divided into the ordinary region and the remap region. The remap region may include remap blocks for replacing a fault block. The ordinary region may include at least one fault block including a fault cell “X” and normal blocks. In the example of FIG. 2, three fault blocks, FB_1, FB_2, and FB_3, may be included in the ordinary region.

In this case, the fault address list including a first fault address corresponding to the first fault block FB_1, a second fault address corresponding to the second fault block FB_2, a third fault address corresponding to the third fault block FB_3, and a start address of the remap region, may be stored in the nonvolatile memory 120.

During the initialization operation, based on the start address of the remap region, the repair engine 110 may map the first fault address to a first remap address corresponding to a first remap block RB_1, may map the second fault address to a second remap address corresponding to a second remap block RB_2, and may map the third fault address to a third remap address corresponding to a third remap block RB_3.

During the initialization operation, the repair engine 110 may generate first recovery information including the fault flag and the first remap address, and may redundantly store the first recovery information in the memory device 200 based on the first fault address. Also, the repair engine 110 may generate second recovery information including the fault flag and the second remap address and may redundantly store the second recovery information in the memory device 200 based on the second fault address. In addition, the repair engine 110 may generate third recovery information including the fault flag and the third remap address and may redundantly store the third recovery information in the memory device 200 based on the third fault address.

In this case, for example, the first remap address may be stored in each of two or more regions among the eight regions of the first fault block FB_1, the second remap address may be stored in each of two or more regions among the eight regions of the second fault block FB_2, and the third remap address may be stored in each of two or more regions among the eight regions of the third fault block FB_3.

According to some implementations, the fault flag and the remap address may be redundantly stored in all the fault blocks. In this case, in an example implementation, the fault flag may be stored in each of the odd-numbered regions of the eight regions of the first fault block FB_1, and the first remap address may be stored in each of the even-numbered regions thereof. Also, the fault flag may be stored in each of the odd-numbered regions of the eight regions of the second fault block FB_2, and the second remap address may be stored in each of the even-numbered regions thereof. In addition, the fault flag may be stored in each of the odd-numbered regions of the eight regions of the third fault block FB_3, and the third remap address may be stored in each of the even-numbered regions thereof. However, implementations are not limited thereto.

Meanwhile, although not illustrated in drawings, the memory cell array 210 may include an ECC block in which parity data corresponding to data stored in a memory block is stored. The size (e.g., 8 bytes or 16 bytes) of the ECC block may be smaller than that of the memory block. In this case, according to some implementations, the remap address of recovery information may be stored in a fault block, and the fault flag of the recovery information may be stored using an ECC-unused bit. In some implementations, the first remap address may be stored in each of the eight regions of the first fault block FB_1, and the fault flag may be stored in some regions of the ECC block corresponding to the first fault block FB_1. Also, the second remap address may be stored in each of the eight regions of the second fault block FB_2, and the fault flag may be stored in some regions of the ECC block corresponding to the second fault block FB_2. In addition, the third remap address may be stored in each of the eight regions of the third fault block FB_3, and the fault flag may be stored in some regions of the ECC block corresponding to the third fault block FB_3. However, implementations are not limited thereto.

As described above, during the initialization operation, recovery information for recovering a fault block may be redundantly stored in the memory device 200 using a fault block.

Afterwards, when a request including the fault address is received from the host device, the controller 100 may read a plurality of recovery information based on the fault address. Also, the controller 100 may identify the fault address and obtain the remap address using the plurality of recovery information. According to the above description, the controller 100 may remap the fault address to the remap address by generating and processing a request including the remap address.

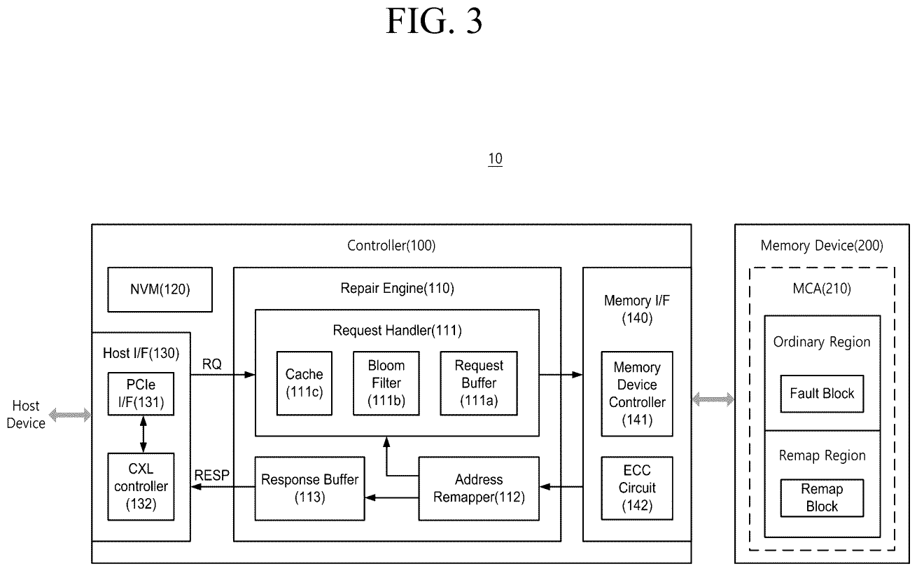

FIG. 3 is a block diagram illustrating a configuration of a memory module according to some implementations of the present disclosure. Referring to FIG. 3, the memory module 10 may include the controller 100 and the memory device 200. The memory module 10 of FIG. 3 may correspond to the memory module 10 of FIG. 1.

In some implementations, the controller 100 may be implemented in one package together with the memory device 200. In some implementations, the controller 100 and the memory device 200 may be implemented with different packages and may then be connected to each other.

The controller 100 may communicate with the host device based on the CXL protocol. Accordingly, the controller 100 implemented with a separate package independently of the memory device 200 may be called a CXL device, but the present disclosure is not limited thereto.

Referring to FIG. 3, the controller 100 may include the repair engine 110, the nonvolatile memory 120, a host interface 130, and a memory interface 140.

The host interface 130 may include a PCIe interface 131 and a CXL controller 132.

The PCIe interface 131 may include a PCIe physical layer. The controller 100 may communicate with the host device or any other CXL device through the PCIe interface 131 on a PCIe bus in compliance with the CXL protocol. In this case, the CXL protocol may include the CXL. io protocol.

The CXL controller 132 may provide the repair engine 110 with a request received from the host device or any other CXL device through the PCIe interface 131. Also, the CXL controller 132 may transfer a response of the repair engine 110 to the PCIe interface 131. To this end, the CXL controller 132 may provide the CXL. mem protocol.

The memory interface 140 may communicate with the memory device 200. For example, the memory interface 140 may communicate with the memory device 200 through a double data rate (DDR) interface. The memory interface 140 may include a memory device controller 141 and an ECC circuit 142.

The memory device controller 141 may provide the memory device 200 with a command, an address, and data corresponding to a request received from the repair engine 110, such that an operation corresponding to the request is performed in the memory device 200 or may transfer data returned from the memory device 200 to the repair engine 110.

The ECC circuit 142 may generate parity information by performing ECC encoding on the data received from the repair engine 110 or the CXL controller 132 and may generate a code word by adding the generated parity information to the data. Also, the ECC circuit 142 may perform ECC decoding on the code word received from the memory device 200 and may correct an error in the data included in the code word. According to some implementations, the ECC circuit 142 may insert the fault flag into a code word using a bit (i.e., an ECC-unused bit), which is not used for the ECC function, from among bits stored in an ECC block of the memory device 200.

The nonvolatile memory 120 may store the fault address list including a plurality of fault addresses, and a start address of the remap region. According to some implementations, the nonvolatile memory 120 may be implemented with an EEPROM or a flash memory. Also, the nonvolatile memory 120 may be a serial presence detect (SPD) device containing various information about the memory module 10, but the present disclosure is not limited thereto. When the nonvolatile memory 120 is implemented with the SPD device, the SPD device may be implemented with a chip independent of the controller 100.

The repair engine 110 may process a request received from the host device through the host interface 130 so as to be transferred to the memory interface 140 and may transfer a response received from the memory device 200 through the memory interface 140 to the host interface 130. In particular, when a request including a fault address is received from the host device, the repair engine 110 may replace a fault block with a remap block by remapping the fault address to a remap address.

To this end, the repair engine 110 may include a request handler 111, an address remapper 112, and a response buffer 113.

The request handler 111 may control a processing sequence of a request received from the host device and a request generated by the request handler 111. To this end, the request handler 111 may include a request buffer 111a, a bloom filter 111b, and a cache memory 111c.

Requests queued into the request buffer 111a may be sequentially transferred to the memory interface 140 so as to be sequentially processed. The request buffer 111a may be a first in first out (FIFO) buffer. Accordingly, the request handler 111 may control a processing sequence of requests by queuing the requests into the request handler 111 in order depending on a sequence of required operations.

For example, to redundantly store recovery information, which is generated based on the initial information stored in the nonvolatile memory 120, in the memory device 200 based on the corresponding fault address, the request handler 111 may generate write requests each including the fault address and may queue the generated write requests into the request buffer 111a. Also, the request handler 111 may queue a request received from the host device through the host interface 130 into the request buffer 111a. Also, the request handler 111 may queue a request including the remap address provided from the address remapper 112 into the request buffer 111a. Also, the request handler 111 may generate a request including the remap address provided from the cache memory 111c and may queue the generated request into the request buffer 111a. Also, the request handler 111 may generate a read request including an address filtered by the bloom filter 111b and may queue the generated read request into the request buffer 111a.

The bloom filter 111b may be configured to output a given value when an input address is included in the plurality of fault addresses of the fault address list. The bloom filter 111b may be implemented, for example, with an SRAM, and the setting operation of the bloom filter 111b may be performed during the initialization operation of the memory module 10 or the controller 100.

Meanwhile, when a write request including a target address is received through the host interface 130, the request handler 111 may input the received write request to the bloom filter 111b. When the given value is output from the bloom filter 111b, the request handler 111 may generate the read request including the target address, and may queue the read request into the request buffer 111a.

The cache memory 111c may store mapping information in which the fault address and the remap address are matched. The cache memory 111c may be implemented with an SRAM, but the present disclosure is not limited thereto.

According to some implementations, during the initialization operation, the repair engine 110 may generate mapping information based on the initial information stored in the nonvolatile memory 120 and may store the generated mapping information in the cache memory 111c. For example, the repair engine 110 may generate mapping information for each of at least some fault addresses among a plurality of fault addresses included in the fault address list by allocating the remap address to each of the at least some fault addresses and may store the generated mapping information in the cache memory 111c.

In this case, the repair engine 110 may select fault addresses from the plurality of fault addresses included in the fault address list as many as the number determined in advance and may generate mapping information corresponding to each of the selected fault addresses. In some implementations, the repair engine 110 may select fault addresses corresponding to fault blocks including relatively more fault cells from among the plurality of fault addresses included in the fault address list and may generate mapping information corresponding to each of the selected fault addresses. To this end, the initial information stored in the nonvolatile memory 120 may further include fault type information about each of the plurality of fault addresses included in the fault address list. The fault type information may indicate the fault degree of a fault block corresponding to a relevant fault address. According to the above description, the repair engine 110 may select fault addresses for generating mapping information based on the fault type information.

Meanwhile, according to some implementations, when the address remapper 112 identifies the target address as a fault address after the initialization operation, the address remapper 112 may generate mapping information by mapping the target address identified as the fault address to the remap address and may store the generated mapping information in the cache memory 111c.

When the received address corresponds to the mapping information stored in the cache memory 111c, the request handler 111 may generate a request including the remap address using the mapping information without an additional operation and may queue the generated request into the request buffer 111a.

When data corresponding to the target address is read from the memory device 200, the address remapper 112 may identify whether the target address is a fault address, based on the data corresponding to the target address. For example, when the fault flag is identified from the data corresponding to the target address, the address remapper 112 may identify the target address as a fault address.

Also, when the target address is identified as a fault address, the address remapper 112 may obtain the remap address from the data corresponding to the target address and may generate a request including the remap address. For example, the address remapper 112 may obtain the remap address by applying the majority voting manner to the data corresponding to the target address. According to the above description, the address remapper 112 may generate a request including the obtained remap address so as to be transferred to the request handler 111. The request transferred to the request handler 111 may be queued into the request buffer 111a.

Also, when the target address is identified as a fault address, as described above, the address remapper 112 may generate mapping information by mapping the target address identified as a fault address to the obtained remap address and may store the generated mapping information in the cache memory 111c.

Meanwhile, when the fault flag is not identified from the data corresponding to the target address, in some cases, the address remapper 112 may transfer the data corresponding to the target address to the response buffer 113 or may transfer an identification result, which indicates that the target address is not the fault address, to the request handler 111.

The response buffer 113 may queue the data transferred from the address remapper 112 and may return the data asynchronously to the host device through the host interface 130. In this case, the reason that the data queued into the response buffer 113 is asynchronously transferred to the host device is that the CXL interface has a variable access latency characteristic and an out-of-order characteristic, which will be described in detail later.

Below, example operations of the repair engine 110 will be described depending on an operation scenario.

According to some implementations of the present disclosure, during the initialization operation, the repair engine 110 may generate recovery information based on initial information stored in the nonvolatile memory 120 and may redundantly store the generated recovery information in the memory device 200 based on the fault address. To this end, the request handler 111 may generate a write request including the fault address and may queue the generated write request into the request buffer 111a.

Also, according to some implementations, during the initialization operation, the repair engine 110 may set the bloom filter 111b based on the fault address list stored in the nonvolatile memory 120 such that a given value (e.g., “1”) is output when an input address is included in a plurality of fault addresses.

Also, according to some implementations, during the initialization operation, the repair engine 110 may generate mapping information, in which the fault address and the remap address are mapped, based on the initial information stored in the nonvolatile memory 120, and may store the generated mapping information in the cache memory 111c.

Meanwhile, according to some implementations, after the initialization operation is completed, the repair engine 110 may receive a first read request including a target address from the host device. In this case, first, the request handler 111 may check whether mapping information including the remap address mapped to the target address is present in the cache memory 111c.

When the mapping information corresponding to the target address is present in the cache memory 111c, the request handler 111 may generate a second read request including the remap address based on the mapping information and may queue the generated second read request into the request buffer 111a.

When data corresponding to the remap address is received from the memory device 200 in response to the second read request, the address remapper 112 may determine whether the remap address is a fault address based on the data corresponding to the remap address. Because the fault flag is absent from the data corresponding to the remap address, the address remapper 112 may transfer the data corresponding to the remap address to the response buffer 113.

Meanwhile, when the mapping information corresponding to the target address is absent from the cache memory 111c, the request handler 111 may queue the first read request into the request buffer 111a.

When data corresponding to the target address is received from the memory device 200 in response to the first read request, the address remapper 112 may determine whether the target address is the fault address based on the data corresponding to the target address.

Because the fault flag is not identified from the data corresponding to the target address, the address remapper 112 may transfer the data corresponding to the target address to the response buffer 113.

However, when the fault flag is identified from the data corresponding to the target address, the address remapper 112 may identify the target address as the fault address and may obtain the remap address from the data corresponding to the target address. In this case, the address remapper 112 may generate a second read request including the remap address and may transfer the generated second read request to the request handler 111.

When the second read request is received, the request handler 111 may check whether mapping information including the remap address mapped to the remap address included in the second read request is present in the cache memory 111c. Because the remap address is a normal address, the mapping information including the remap address mapped to the remap address may not exist. Accordingly, the request handler 111 may queue the second read request into the request buffer 111a.

When data corresponding to the remap address is received from the memory device 200 in response to the second read request, the address remapper 112 may determine whether the remap address is the fault address based on the data corresponding to the remap address. Because the fault flag is absent from the data corresponding to the remap address, the address remapper 112 may transfer the data corresponding to the remap address to the response buffer 113.

According to some implementations, when the target address is identified as the fault address, the address remapper 112 may generate mapping information by mapping the target address to the remap address and may store the generated mapping information in the cache memory 111c. After the mapping information in which the target address identified as the fault address is mapped to the remap address is stored in the cache memory 111c, when a third request including the same target address is received, the request handler 111 may immediately generate a fourth request including the remap address using the mapping information stored in the cache memory 111c and may queue the generated fourth request into the request buffer 111a. In this case, the third request and the fourth request may be read requests or may be write requests.

Meanwhile, according to some implementations, after the initialization operation is completed, the repair engine 110 may receive a first write request including a target address from the host device. In this case, first, the request handler 111 may check whether mapping information including the remap address mapped to the target address is present in the cache memory 111c.

When the mapping information corresponding to the target address is present in the cache memory 111c, the request handler 111 may generate a second write request including the remap address based on the mapping information and may queue the generated second write request into the request buffer 111a. In this case, an operation corresponding to the write request may be performed based on the remap address.

Meanwhile, when the mapping information corresponding to the target address is absent from the cache memory 111c, the request handler 111 may input the target address to the bloom filter 111b.

When the given value is not output from the bloom filter 111b, the request handler 111 may queue the first write request into the request buffer 111a. In this case, an operation corresponding to the write request may be performed based on the target address.

When the given value is output from the bloom filter 111b, the request handler 111 may generate a read request including the target address and may queue the generated read request into the request buffer 111a. When data corresponding to the target address is received from the memory device 200, the address remapper 112 may identify whether the target address is the fault address, based on the data corresponding to the target address.

When the fault flag is not identified from the data corresponding to the target address, the address remapper 112 may transfer, to the request handler 111, an identification result indicating the target address is not the fault address and may queue the first write request in the request buffer 111a. In this case, an operation corresponding to the write request may be performed based on the target address.

However, when the fault flag is identified from the data corresponding to the target address, the address remapper 112 may identify the target address as the fault address and may obtain the remap address corresponding to the target address. In this case, the address remapper 112 may generate the second write request including the remap address, and may transfer the generated second write request to the request handler 111.

When the second write request is received, the request handler 111 may check whether mapping information including the remap address mapped to the remap address included in the second write request is present in the cache memory 111c. Because the remap address is a normal address, the remap address mapped to the remap address may not exist. Accordingly, the request handler 111 may input the second write request to the bloom filter 111b. Since the remap address is not the fault address, the bloom filter 111b may not output the given value, and the request handler 111 may queue the second write request into the request buffer 111a. In this case, an operation corresponding to the write request may be performed based on the remap address.

The probability that a positive error is capable of occurring at an output due to the characteristic of the bloom filter 111b may exist, but the probability that a negative error is capable of occurring at an output may not exist. Accordingly, according to the above implementation of the present disclosure, a situation where data is written in a fault block may be prevented.

According to some implementations, when the target address is identified as the fault address, the address remapper 112 may store mapping information, in which the target address is mapped to the remap address, in the cache memory 111c. Afterwards, when the third request including the same target address is received, the request handler 111 may immediately generate the fourth request including the remap address using the mapping information stored in the cache memory 111c and may queue the generated fourth request into the request buffer 111a. In this case, the third request and the fourth request may be read requests or may be write requests.

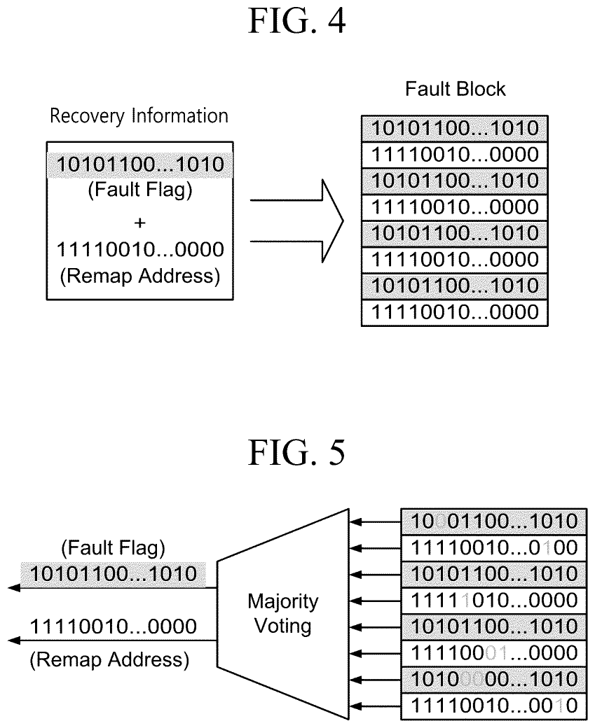

FIG. 4 is a diagram for describing a method of storing recovery information, according to some implementations of the present disclosure.

During the initialization operation (or during a booting process), the repair engine 110 may generate recovery information including the fault flag and the remap address based on initial information stored in the nonvolatile memory 120. Referring to FIG. 4, the repair engine 110 may generate recovery information including a fault flag of “10101100 . . . 1010” and a remap address of “11110010 . . . 0000” in association with one fault address.

In this case, according to some implementations, the fault flag may include a hash value of the fault address. Because the hash value varies depending on a fault address, in this case, a value of the fault flag may be determined differently for each recovery information. According to some implementations, the fault flag may include a preset constant value (or a preset bit pattern). In this case, the fault flags of all recovery information may have the same value.

Meanwhile, the repair engine 110 may redundantly store the generated recovery information in the memory device 200 based on the fault address. According to some implementations, the repair engine 110 may store both the fault flag and the remap address in fault blocks. For example, the repair engine 110 may store the fault flag in each of a plurality of first regions of a fault block and may store the remap address in each of a plurality of second regions of the fault block. Referring to FIG. 4, the fault flag may be stored in each of four odd-numbered regions among eight regions of the fault block, and the remap address may be stored in each of four even-numbered regions thereof. However, implementations are not limited thereto.

FIG. 5 is a diagram for describing a method of obtaining a remap address, according to some implementations of the present disclosure. In FIG. 5, it is assumed that the recovery information of FIG. 4 is stored.

According to some implementations, when data corresponding to a target address is read, the address remapper 112 may apply a majority voting manner to data corresponding to the plurality of first regions of the fault block from among the data corresponding to the target address. In this case, the plurality of first regions may be regions in which the fault flag is stored, from among a plurality of regions of the fault block.

Referring to FIG. 5, the address remapper 112 may obtain the fault flag of “10101100 . . . 1010” by applying the majority voting manner to the data corresponding to the plurality of first regions in units of bits.

When the fault flag is obtained, the address remapper 112 may obtain the remap address by applying the majority voting manner to data corresponding to the plurality of second regions of the fault block from among the data corresponding to the target address. In this case, the plurality of second regions may be regions in which the remap address is stored, from among the plurality of regions of the fault block.

Referring to FIG. 5, the address remapper 112 may obtain the remap address of “11110010 . . . 0000” by applying the majority voting manner to the data corresponding to the plurality of second regions in units of bits. In this case, the address remapper 112 may generate the second request including the obtained remap address and may provide the generated second request to the request handler 111.

Because the fault block includes a fault cell(s), the fault block may include an error in which a bit value(s) is flipped. Comparing the data stored in the fault block of FIG. 4 with the read data of FIG. 5, it may be understood that some bits of the read data are flipped.

However, according to implementations of the present disclosure, because the fault flag and the remap address are redundantly stored in each of the plurality of regions of the fault block, and recovery information is identified by applying the majority voting manner, the reliability may be improved.

The case where the fault flag or the remap address is obtained by applying the majority voting manner in units of bits is described above as an example, but implementations are not limited thereto. For example, the fault flag or the remap address may be obtained by applying the majority voting manner in units of fault flag or remap address.

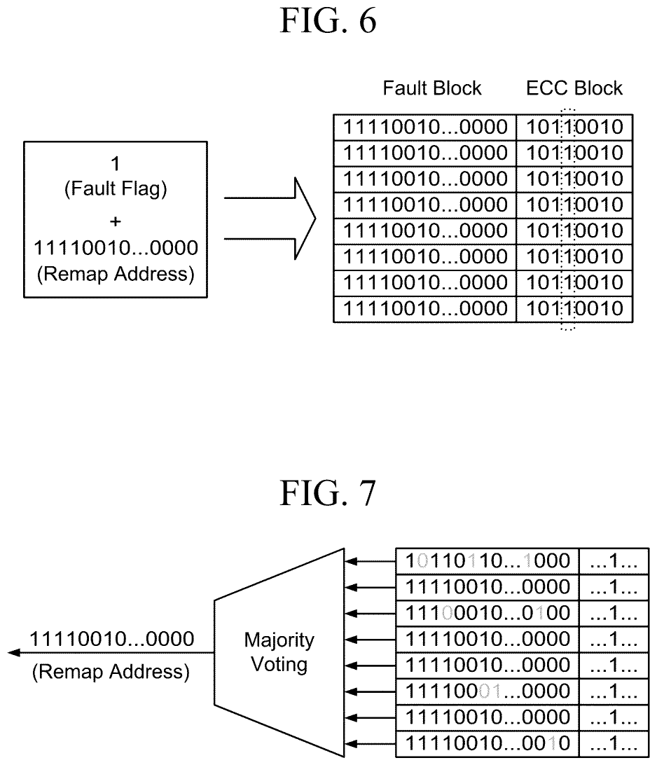

FIG. 6 is a diagram for describing a method of storing recovery information, according to some implementations of the present disclosure.

During the initialization operation (or during a booting process), the repair engine 110 may generate recovery information including the fault flag and the remap address based on initial information stored in the nonvolatile memory 120. Referring to FIG. 6, the repair engine 110 may generate recovery information including a fault flag of “1” and a remap address of “11110010 . . . 0000” in association with one fault address. That is, according to some implementations, the fault flag may include one bit value. However, the present disclosure is not limited thereto. According to some implementations, the fault flag may be expressed using two or more bit values.

Meanwhile, the repair engine 110 may redundantly store the generated recovery information in the memory device 200 based on the fault address. In this case, according to some implementations, the repair engine 110 may store the remap address in each of a plurality of regions of the fault block and may store the fault flag in each of some regions of an ECC block corresponding to the fault block. Herein, the some regions of the ECC block may be regions corresponding to bits not used for the ECC function from among bits stored in the ECC block. That is, according to some implementations, the fault flag may be stored using an unused bit among ECC parity bits.

Referring to FIG. 6, the remap address may be stored in each of all eight regions of the fault block, and the fault flag may be stored in each of regions of the ECC block, which correspond to the fourth bit among the parity bits. However, the present disclosure is not limited thereto. The number of remap addresses or fault flags that are stored based on the fault address may vary depending on implementations.

FIG. 7 is a diagram for describing a method of obtaining a remap address, according to some implementations of the present disclosure. In FIG. 7, it is assumed that the recovery information of FIG. 6 is stored.

According to some implementations, when data corresponding to a target address are read, the address remapper 112 may check whether data corresponding to the some regions of the ECC blocks from among the data corresponding to the target address correspond to the fault flag. In this case, the some regions of the ECC block may be regions in which the fault flag is stored. Referring to FIG. 7, the address remapper 112 may check whether the data corresponding to the some regions of the ECC block correspond to the fault flag of “1”.

When the data corresponding to the some regions of the ECC block correspond to the fault flag, the address remapper 112 may obtain the remap address by applying the majority voting manner to data corresponding to the plurality of regions of the fault block from among the data corresponding to the target address. In this case, the plurality of regions may be regions of the fault block, in which the remap address is stored.

Referring to FIG. 7, the address remapper 112 may obtain the remap address of “11110010 . . . 0000” by applying the majority voting manner to the data corresponding to the plurality of regions of the fault block, in which the remap address is stored, in units of bits. In this case, the address remapper 112 may generate the second request including the obtained remap address, and may provide the generated second request to the request handler 111. The case where the remap address is obtained by applying the majority voting manner in units of bits is described above as an example, but implementations are not limited thereto.

Meanwhile, comparing the data stored in the fault block of FIG. 6 with the read data of FIG. 7, it may be understood that some bits of the read data are flipped. However, according to implementations of the present disclosure, because the remap address is redundantly stored in the plurality of regions of the fault block and the remap address is obtained by applying the majority voting manner, the reliability may be improved.

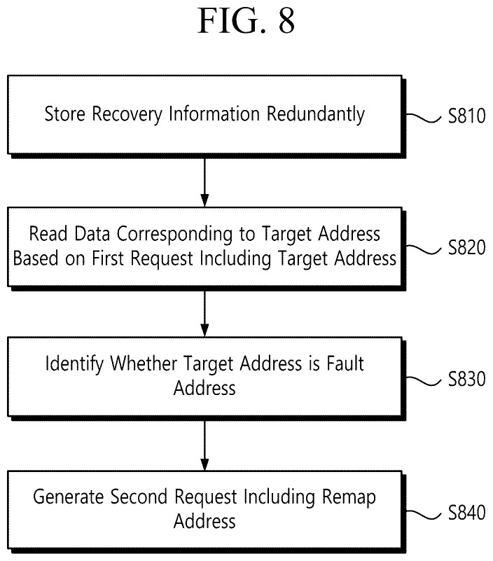

FIG. 8 is a flowchart illustrating an operating method of a memory module according to some implementations of the present disclosure. Referring to FIG. 8, in operation S810, the memory module 10 may redundantly store recovery information in the memory device 200 based on a fault address corresponding to a fault block.

For example, the memory module 10 may include the nonvolatile memory 120 that stores initial information including the fault address list and a start address of a remap region. Accordingly, during the initialization operation, the memory module 10 may allocate different remap addresses to a plurality of fault addresses included in the fault address list and may generate recovery information corresponding to each fault address. In this case, each recovery information may include the remap address mapped to the corresponding fault address and the fault flag. According to the above description, the memory module 10 may redundantly store the recovery information corresponding to each fault address in the memory device 200 based on the corresponding fault address.

According to some implementations, based on a fault address, the memory module 10 may store the fault flag in each of a plurality of first regions of a fault block and may store the remap address in each of a plurality of second regions of the fault block. In some implementations, based on a fault address, the memory module 10 may store the fault flag in each of some regions of an ECC block corresponding to a fault block and may store the remap address in each of a plurality of regions of the fault block.

Meanwhile, according to some implementations, the memory module 10 may include the bloom filter 111b that is configured to output a given value when an input address is included in the plurality of fault addresses. During the initialization operation of the memory module 10, the bloom filter 111b may be set as described above, based on the fault address list.

In operation S820, the memory module 10 may read data corresponding to the target address from the memory device 200 based on a first request including the target address.

In operation S830, the memory module 10 may identify whether the target address is the fault address, based on the data corresponding to the target address.

According to some implementations, the memory module 10 may apply the majority voting manner to data corresponding to the plurality of first regions from among the data corresponding to the target address, and when the fault flag is obtained as a result of applying the majority voting manner, the memory module 10 may identify that the target address is the fault address.

According to some implementations, the memory module 10 may check whether data corresponding to the some regions of the ECC block from among the data corresponding to the target address correspond to the fault flag, and when the data corresponding to the some regions of the ECC block correspond to the fault flag, the memory module 10 may identify that the target address is the fault address.

When the target address is identified as the fault address, in operation S840, the memory module 10 may generate a second request including the remap address based on the data corresponding to the target address.

According to some implementations, when the target address is identified as a fault address, the memory module 10 may obtain the remap address by applying the majority voting manner to data corresponding to the plurality of second regions from among the data corresponding to the target address and may generate the second request including the obtained remap address.

According to some implementations, the memory module 10 may obtain the remap address by applying the majority voting manner to data corresponding to the plurality of regions of the fault block from among the data corresponding to the target address and may generate the second request including the obtained remap address.

As the memory module 10 performs an operation corresponding to the second request, the fault address may be remapped to the remap address.

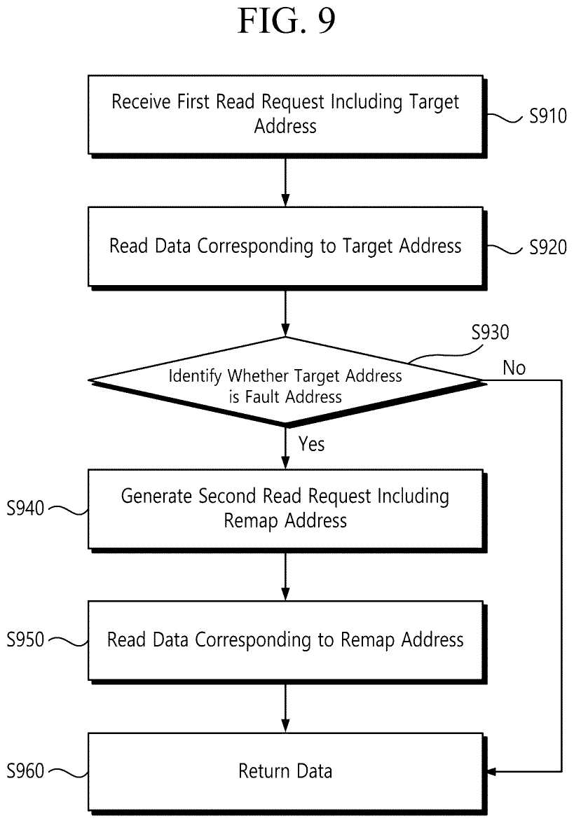

FIG. 9 is a flowchart illustrating an operating method of a memory module according to some implementations of the present disclosure. In FIG. 9, it is assumed a state where the initialization operation (e.g., operation S810) is completed.

Referring to FIG. 9, in operation S910, the memory module 10 may receive a first read request including a target address from the host device. In operation S920, the memory module 10 may read data corresponding to the target address from the memory device 200 depending on the first read request. Operation S910 and operation S920 may correspond to operation S820 of FIG. 8.

In operation S930, the memory module 10 may identify whether the target address is the fault address, based on the data corresponding to the target address. For example, when the fault flag is identified from the data corresponding to the target address, the memory module 10 may identify the target address as the fault address; and when the fault flag is not identified from the data corresponding to the target address, the memory module 10 may identify that the target address is not the fault address. Operation S930 may correspond to operation S830 of FIG. 8.

When the target address is identified as the fault address, in operation S940, the memory module 10 may generate a second read request including the remap address. Operation S940 may correspond to operation S840 of FIG. 8.

Afterwards, in operation S950, the memory module 10 may read data corresponding to the remap address from the memory device 200 based on the second read request; in operation S960, the memory module 10 may return the data corresponding to the remap address to the host device.

Meanwhile, when the target address is identified in operation S930 as not being a fault address, in operation S960, the memory module 10 may return the data corresponding to the target address to the host device.

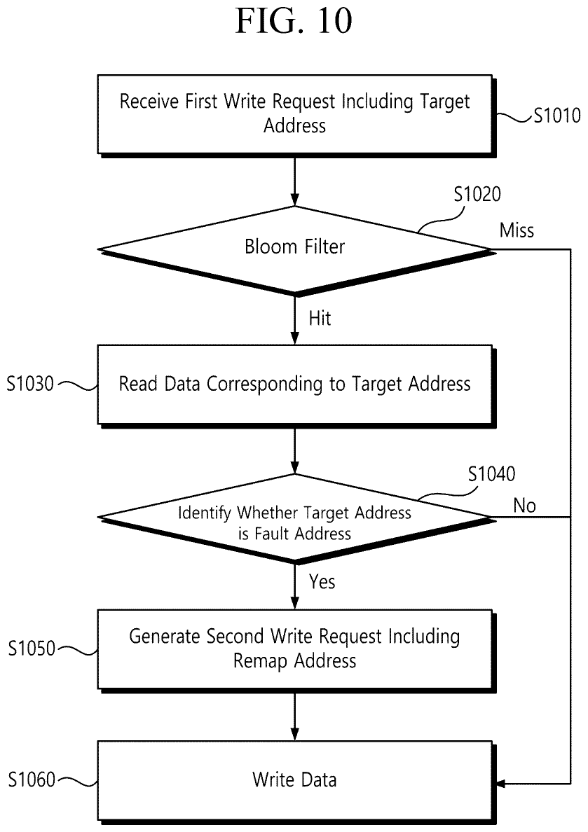

FIG. 10 is a flowchart illustrating an operating method of a memory module according to some implementations of the present disclosure. In FIG. 10, it is assumed a state where the initialization operation (e.g., operation S810) is completed.

Referring to FIG. 10, in operation S1010, the memory module 10 may receive a first write request including a target address from the host device. In operation S1020, the memory module 10 may input the target address to the bloom filter 111b.

When a given value (e.g., “1”) is output from the bloom filter 111b (Hit in operation S1020), in operation S1030, the memory module 10 may read data corresponding to the target address from the memory device 200. Operation S1010 and operation S1030 may correspond to operation S820 of FIG. 8.

Afterwards, in operation S1040, the memory module 10 may identify whether the target address is the fault address, based on the data corresponding to the target address. For example, when the fault flag is identified from the data corresponding to the target address, the memory module 10 may identify the target address as the fault address; and when the fault flag is not identified from the data corresponding to the target address, the memory module 10 may identify that the target address is not the fault address. Operation S1040 may correspond to operation S830 of FIG. 8.

When the target address is identified as the fault address, in operation S1050, the memory module 10 may generate a second write request including the remap address. Operation S1050 may correspond to operation S840 of FIG. 8. Afterwards, in operation S1060, the memory module 10 may write the data in a region of the memory device 200, which corresponds to the remap address, based on the second write request.

Meanwhile, when a value (e.g., “0”) different from the given value is output from the bloom filter 111b (Miss in operation S1020), in operation S1060, the memory module 10 may write the data in a region of the memory device 200, which corresponds to the target address, based on the first write request.

Also, even when the target address is identified in operation S1040 as not being the fault address, in operation S1060, the memory module 10 may write the data in the region of the memory device 200, which corresponds to the target address, based on the first write request.

Meanwhile, some implementations in which operation S1040 is included are described with reference to FIG. 10. However, according to some implementations, operation S1040 may be omitted. That is, according to some implementations, when the data corresponding to the target address is read in operation S1030, the memory module 10 may generate the second write request including the remap address in operation S1050, without identifying the fault flag from the data corresponding to the target address.

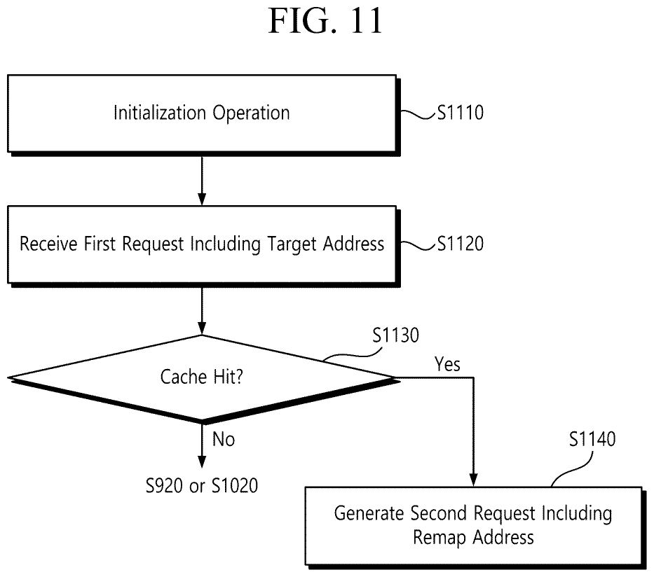

Below, implementations associated with the cache memory 111c will be described with reference to FIG. 11. FIG. 11 is a flowchart illustrating an operating method of a memory module according to some implementations of the present disclosure.

Referring to FIG. 11, in operation S1110, the memory module 10 may perform the initialization operation. For example, during the initialization operation, the memory module 10 may generate recovery information based on initial information stored in the nonvolatile memory 120 and may redundantly store the generated recovery information in the memory device 200 based on the fault address. During the initialization operation, based on the fault address list stored in the nonvolatile memory 120, the memory module 10 may set the bloom filter 111b such that a given value (e.g., “1”) is output when an input address is included in a plurality of fault addresses. Also, during the initialization operation, the memory module 10 may generate mapping information, in which the fault address and the remap address are mapped, based on the initial information stored in the nonvolatile memory 120, and may store the generated mapping information in the cache memory 111c.

In operation S1120, the memory module 10 may receive a first request including a target address from the host device. In operation S1130, the memory module 10 may check the mapping information stored in the cache memory 111c to check whether the remap address mapped to the target address exists.

When the remap address mapped to the target address exists, in operation S1140, the memory module 10 may immediately generate a second request including the remap address.

Meanwhile, when the remap address mapped to the target address does not exist, the memory module 10 may perform the following operations from operation S920 of FIG. 9 or operation S1020 of FIG. 10. In detail, when the first request received in operation S1120 is a first read request, the memory module 10 may perform operation S920 of FIG. 9 and operations following operation S920. Also, when the first request received in operation S1120 is a first write request, the memory module 10 may perform operation S1020 of FIG. 10 and operations following operation S1020.

Meanwhile, according to some implementations, the mapping information may be generated after the initialization operation and may then be stored in the cache memory 111c.

For example, when it is identified in operation S930 of FIG. 9 that the target address is the fault address, the memory module 10 may generate mapping information in which the target address identified as the fault address and the remap address are mapped and may store the generated mapping information in the cache memory 111c. In this case, the memory module 10 may generate the mapping information using the remap address obtained in operation S940.

In some implementations, when it is identified in operation S1040 of FIG. 10 that the target address is the fault address, the memory module 10 may generate mapping information in which the target address identified as the fault address and the remap address are mapped and may store the generated mapping information in the cache memory 111c. In this case, the memory module 10 may generate the mapping information using the remap address obtained in operation S1050.

After the mapping information in which the target address identified as a fault address is mapped to the remap address is stored in the cache memory 111c, when a third request including the same target address is received, the memory module 10 may immediately generate a fourth request including the remap address using the mapping information stored in the cache memory 111c.

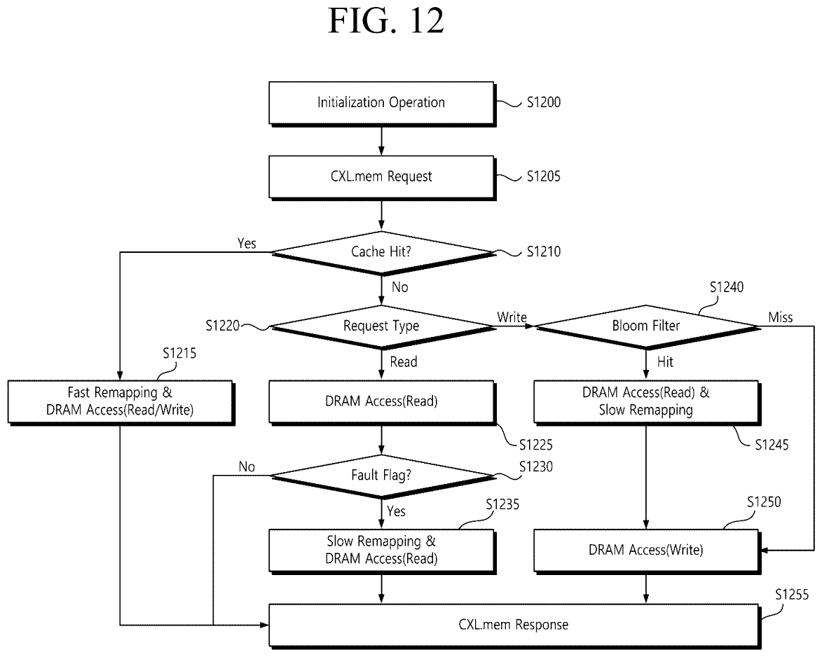

FIG. 12 is a flowchart illustrating an operating method of a repair engine according to some implementations of the present disclosure. In FIG. 12, it is assumed that the memory device 200 is a DRAM.

Referring to FIG. 12, in operation S1200, the repair engine 110 may perform the initialization operation. Operation S1200 may correspond to operation S1110 of FIG. 11. For example, during the initialization operation, the repair engine 110 may redundantly store recovery information about each fault address included in the fault address list in the corresponding fault block of the DRAM. Also, during the initialization operation, the repair engine 110 may set the bloom filter 111b to output a given value when any one of a plurality of fault addresses included in the fault address list is input. Also, during the initialization operation, the repair engine 110 may store mapping information about some of the plurality of fault addresses included in the fault address list in the cache memory 111c.

In operation S1205, the repair engine 110 may receive a request that is based on the CXL. mem protocol. In this case, the request may include a read request for a target address or a write request for a target address.

In operation S1210, the repair engine 110 may check whether mapping information corresponding to the target address is present in the cache memory 111c. When the mapping information corresponding to the target address is present in the cache memory 111c (Yes in operation S1210), the repair engine 110 may perform operation S1215.

In operation S1215, the repair engine 110 may remap the target address to the remap address based on the mapping information and may process the request based on the remap address. For example, the repair engine 110 may remap the target address to the remap address by obtaining the remap address from the mapping information and generating a request including the obtained remap address. According to the above description, the repair engine 110 may process the request based on the remap address, by processing the request including the remap address. For example, when the request received in operation S1205 is a read request, the repair engine 110 may read data from the DRAM based on the remap address. Also, when the request received in operation S1205 is a write request, the repair engine 110 may write data in the DRAM based on the remap address.

In this case, an operation of remapping an address using mapping information stored in the cache memory 111c may be called fast remapping. The reason is that the operation of remapping an address using mapping information stored in the cache memory 111c is relatively faster than the operation of remapping an address using recovery information stored in a fault block. According to some implementations, the fast remapping operation may be performed by the request handler 111 described above.

In this case, in operation S1215, the repair engine 110 may return a response to the request to the host device based on the CXL. mem protocol. For example, the repair engine 110 may return the data read in operation S1215 to the host device or may return a result of the write request processed in operation S1215 to the host device.

Meanwhile, when the mapping information corresponding to the target address is absent from the cache memory 111c (No in operation S1210), the operation of the repair engine 110 may change depending on the type of the request.

For example, when the request received in operation S1205 is the read request (Read in operation S1220), the repair engine 110 may perform operation S1225. In operation S1225, the repair engine 110 may read data from the DRAM based on the target address.

Afterwards, in operation S1230, the repair engine 110 may identify whether the target address is the fault address, based on the read data. For example, when the fault flag is identified from the read data, the repair engine 110 may identify the target address as the fault address. Also, when the fault flag is not identified from the read data, the repair engine 110 may identify that the target address is not the fault address. When it is identified that the target address is not the fault address (No in operation S1230), the repair engine 110 may perform operation S1255. In operation S1255, the repair engine 110 may return the data read in operation S1225, that is, the data read based on the target address, to the host device based on the CXL. mem protocol.

When it is determined that the target address is the fault address (as indicated by ‘Yes’ in operation S1230), the repair engine 110 may perform operation S1235. In operation S1235, the repair engine 110 may remap the target address to the remap address and may read data from the DRAM based on the remap address. For example, the repair engine 110 may remap the target address to the remap address by obtaining the remap address by applying the majority voting manner to the data read in operation S1225 and generating the read request including the obtained remap address. According to the above description, the repair engine 110 may read data based on the remap address by processing the read request including the remap address.

In this case, an operation of remapping an address using data read based on a target address identified as the fault address, that is, an operation of remapping an address using recovery information stored in a fault block may be called slow remapping. According to some implementations, the slow remapping operation may be performed by the address remapper 112 described above.

In this case, in operation S1255, the repair engine 110 may return the data obtained based on the remap address to the host device based on the CXL. mem protocol.

Meanwhile, when the request received in operation S1205 is the write request (Write in operation S1220), the repair engine 110 may perform operation S1240. In operation S1240, the repair engine 110 may input the target address to the bloom filter 111b.

When the bloom filter 111b does not output the given value based on the target address (Miss in operation S1240), the repair engine 110 may perform operation S1250. The case where the bloom filter 111b outputs a value different from the given value may be determined as the case where the target address is not the fault address. Accordingly, in operation S1250, the repair engine 110 may write data in the DRAM based on the target address. In this case, in operation S1255, the repair engine 110 may return a result of the write request to the host device based on the CXL. mem protocol.

Meanwhile, when the bloom filter 111b outputs the given value based on the target address (Hit in operation S1240), the repair engine 110 may perform operation S1245. The case where the bloom filter 111b outputs the given value may be determined as the case where the target address is the fault address. Accordingly, in operation S1245, the repair engine 110 may read data from the DRAM based on the target address and may remap the target address to the remap address. For example, the repair engine 110 may remap the target address to the remap address by obtaining the remap address by applying the majority voting manner to the data read based on the target address and generating the write request including the obtained remap address. Because the remapping operation performed in operation S1245 uses the data read based on the target address determined as the fault address through the bloom filter 111b, the remapping operation performed in operation S1245 may also be the slow remapping operation.

In operation S1250, the repair engine 110 may write data in the DRAM based on the remap address by processing the write request including the remap address. In this case, in operation S1215, the repair engine 110 may return a result of the write request to the host device based on the CXL.mem protocol.

Meanwhile, as described above, the memory module 10 or the controller 100 according to implementations of the present disclosure may recover the hardware fault of the memory device 200 by storing recovery information in the memory device 200 and remapping the fault address to the remap address using the recovery information during an operation. In this case, a storage space for storing recovery information may be required, and a latency necessary to access the stored recovery information may be added. This may mean that spatial and temporal overheads are caused.

However, because the memory module 10 or the controller 100 according to implementations of the present disclosure redundantly stores recovery information in an unused space of a fault block or an ECC block, the memory module 10 or the controller 100 according to implementations of the present disclosure may secure the reliability while reducing a usage space of the memory device 200 for storing recovery information. Also, as described above, the memory module 10 or the controller 100 according to implementations of the present disclosure may minimize the latency, which is capable of being caused during the remapping operation, using the bloom filter 111b and/or the cache memory 111c.

Meanwhile, the DDR interface has a limitation that responses to requests, which the host device generates, should be returned in order within a given time. That is, the DDR interface that complies with the JEDEC standard has a strict timing limitation and an in-order characteristic. In contrast, unlike the DDR interface, the CXL interface permits variable access latency and has the out-of-order characteristic.

Because the memory module 10 or the controller 100 according to implementations of the present disclosure is capable of using the CXL interface (e.g., the PCIe physical layer and the CXL.mem protocol), the memory module 10 or the controller 100 according to implementations of the present disclosure may operate by utilizing the above characteristic of the CXL interface. According to the above description, the loss of delay according to two read operations (i.e., the read operation based on the fault address and the read operation based on the remap address) performed to process a request including a fault address may be alleviated.

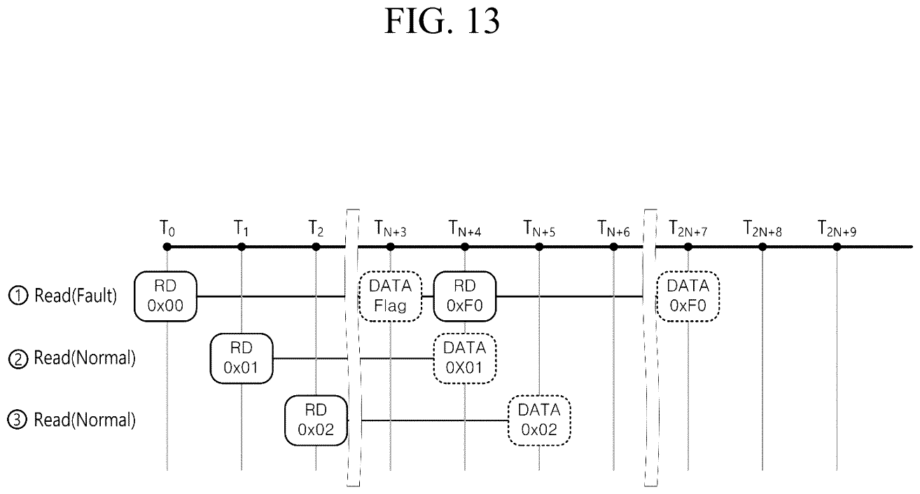

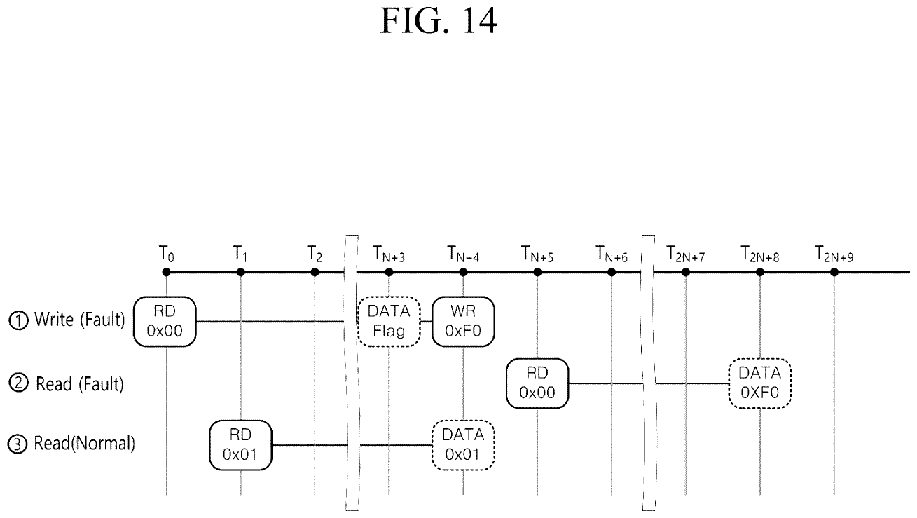

Below, implementations of the present disclosure associated with a request of a host device to be processed on the CXL interface will be described with reference to FIGS. 13 and 14. In FIGS. 13 and 14, \textcircled{1}, \textcircled{2} and \textcircled{3} indicate the order in which requests are input to the memory module 10.

FIG. 13 shows the order in which requests of different addresses are processed. Referring to FIG. 13, for example, a first read request for a fault address of 0×00, a second read request for a normal address of 0×01, and a third read request for a normal address of 0×02 may be sequentially received by the memory module 10.

Because the first read request is a request for the fault address, the memory module 10 may process a first read operation through two read operations (a read operation for the fault address of 0×00 and a read operation for a remap address of 0×F0).

In this case, due to the characteristic of the CXL interface, even though second and third read requests following the first read request are received while processing the first read request, the memory module 10 may process the second and third read requests. Also, even before the first read request is completely processed (e.g., even before the read request for the remap address of 0×F0 is generated), the memory module 10 may return responses to the second and third read requests to the host device. According to the above description, the performance reduction caused by an additional access operation necessary to remap the fault address may be alleviated.

FIG. 14 shows the order in which requests of the same address are processed. According to some implementations of the present disclosure, when requests of the same address are received, the memory module 10 may process the requests in the order of receiving the requests.

Referring to FIG. 14, a first write request for a fault address of 0×00 may be received, and then, a first read request for the same fault address of 0×00 may be received. In this case, the memory module 10 may complete the processing of the first write request and may then process the first read request.

According to various implementations of the present disclosure described above, a CXL device capable of recovering a fault of a memory device more efficiently, a memory module including the same, and an operating method of the memory module may be provided.

While this disclosure contains many specific implementation details, these should not be construed as limitations on the scope of what may be claimed, equivalents thereof, as well as claims to be described later. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While the present disclosure has been described with reference to implementations thereof, it will be apparent to those of ordinary skill in the art that various changes and modifications may be made thereto without departing from the spirit and scope of the present disclosure as set forth in the following claims.

What is claimed is:

1. A memory module comprising:
a memory device including a memory cell array, wherein the memory cell array includes (i) a fault block comprising a fault cell and (ii) a remap block for replacing the fault block; and
a controller configured to communicate with a host device through a compute express link (CXL) interface and control the memory device,
wherein the controller is configured to:
redundantly store recovery information including a fault flag and a remap address corresponding to the remap block in the memory device based on a fault address corresponding to the fault block;
read data corresponding to a target address from the memory device, based on receiving a first request including the target address from the host device;
determine that the target address is the fault address, based on the data corresponding to the target address; and
based on the determination that the target address is the fault address, generate a second request including the remap address based on the data corresponding to the target address.

2. The memory module of claim 1, comprising:
a nonvolatile memory configured to store a fault address list including a plurality of fault addresses respectively corresponding to a plurality of fault blocks included in the memory cell array, and a start address of a remap region, the remap region including a plurality of remap blocks of the memory cell array,
wherein during an initialization operation, the controller is configured to:
map a plurality of remap addresses to the plurality of fault addresses respectively, based on the start address of the remap region; and
redundantly store respective recovery information associated with each fault address of the plurality of fault addresses, wherein the respective recovery information includes a remap address and a fault flag based on each fault address of the plurality of fault addresses.

3. The memory module of claim 1, wherein the controller is configured to:
store the fault flag in each first region of a plurality of first regions of the fault block and store the remap address in each second region of a plurality of second regions of the fault block;
apply a majority voting manner to data corresponding to the plurality of first regions from among the data corresponding to the target address;
based on the fault flag being obtained as a result of applying the majority voting manner, obtain the remap address by applying the majority voting manner to data corresponding to the plurality of second regions from among the data corresponding to the target address; and
generate the second request including the obtained remap address.

4. The memory module of claim 3, wherein the fault flag includes a hash value of the fault address or a preset constant value.

5. The memory module of claim 1, wherein the controller is configured to:
store the fault flag in each region of a plurality of regions of an error correction code (ECC) block corresponding to the fault block and store the remap address in each region of a plurality of regions of the fault block;
determine that data corresponding to the plurality of regions of the ECC bock from among the data corresponding to the target address includes the fault flag;
based on the determination that the data corresponding to the plurality of regions includes the fault flag, obtain the remap address by applying a majority voting manner to data corresponding to the plurality of regions of the fault block from among the data corresponding to the target address; and
generate the second request including the obtained remap address.

6. The memory module of claim 5, wherein the plurality of regions of the ECC block correspond to bits not used for an ECC function from among bits stored in the ECC block.

7. The memory module of claim 1, wherein the first request comprises a first read request including the target address,
wherein the controller is configured to:
based on the fault flag being identified from the data corresponding to the target address, determine that the target address as the fault address and generate a second read request including the remap address;
read data corresponding to the remap address from the memory device based on the second read request; and
provide the data corresponding to the remap address to the host device.

8. The memory module of claim 7, wherein the controller is configured to, based on the fault flag being not identified from the data corresponding to the target address, provide the data corresponding to the target address to the host device.

9. The memory module of claim 2, wherein the controller includes:
a bloom filter configured to output a given value based on the fault address list based on the target address input to the bloom filter being included in the plurality of fault addresses.

10. The memory module of claim 9, wherein the first request comprises a first write request including the target address, and
wherein the controller is configured to:
input the target address to the bloom filter in response to receiving the first write request;
based on the given value being output from the bloom filter, read the data corresponding to the target address from the memory device; and
based on the given value being not output from the bloom filter, write the data corresponding to the target address in a region of the memory cell array, based on the first write request.

11. The memory module of claim 10, wherein the controller is configured to:
based on the fault flag being identified from the data corresponding to the target address, determine the target address as a fault address from among the plurality of fault addresses and generate a second write request including the remap address; and
write data corresponding to the remap address in the region of the memory cell array, based on the second write request.

12. The memory module of claim 11, wherein the controller is configured to, based on the fault flag being not identified from the data corresponding to the target address, write the data corresponding to the target address in the region of the memory cell array, based on the first write request.

13. The memory module of claim 1, wherein the memory cell array includes:
a first fault block; and
a first remap block for replacing the first fault block,
wherein the controller includes:
a cache memory configured to store mapping information, the mapping information including a first fault address corresponding to the first fault block and a first remap address corresponding to the first remap block.

14. The memory module of claim 13, wherein the controller is configured to:
based on receiving the first request including the target address, determine that the target address corresponds to the first fault address, based on the mapping information stored in the cache memory; and
based on the determination that the target address corresponds to the first fault address, generate a third request including the first remap address using the mapping information stored in the cache memory.

15. A compute express link (CXL) device comprising:
a host interface configured to communicate with a host device using a CXL protocol; and
a memory controller configured to control a memory device and process a request from the host device received through the host interface,
wherein the memory controller includes a repair engine configured to replace a fault block of the memory device with a remap block of the memory device,
wherein the repair engine is configured to:
redundantly store recovery information including a fault flag and a remap address corresponding to the remap block in the memory device based on a fault address corresponding to the fault block;
read data corresponding to a target address from the memory device, based on receiving a first request including the target address from the host device;
determine that the target address is the fault address, based on the data corresponding to the target address; and
based on the determination that the target address is the fault address, generate a second request including the remap address based on the data corresponding to the target address.

16. The CXL device of claim 15, comprising:
a nonvolatile memory configured to store a fault address list including a plurality of fault addresses respectively corresponding to a plurality of fault blocks included in the memory device, and a start address of a remap region, the remap region including a plurality of remap blocks of the memory device,
wherein during an initialization operation, the repair engine is configured to:
map a plurality of remap addresses to the plurality of fault addresses respectively, based on the start address of the remap region; and
redundantly store respective recovery information associated with each fault address of the plurality of fault addresses, wherein the respective recovery information includes a remap address and the fault flag based on each fault address of the plurality of fault addresses.

17. The CXL device of claim 15, wherein the repair engine is configured to:
store the fault flag in each first region of a plurality of first regions of the fault block and store the remap address in each second region of a plurality of second regions of the fault block;
apply a majority voting manner to data corresponding to the plurality of first regions from among the data corresponding to the target address;
based on the fault flag being obtained as a result of applying the majority voting manner, obtain the remap address by applying the majority voting manner to data corresponding to the plurality of second regions from among the data corresponding to the target address; and
generate the second request including the obtained remap address.

18. The CXL device of claim 15, wherein the repair engine is configured to:
store the fault flag in each region of a plurality of regions of an error correction code (ECC) block corresponding to the fault block and store the remap address in each region of a plurality of regions of the fault block;
determine that data corresponding to the plurality of regions of the ECC bock from among the data corresponding to the target address correspond to the fault flag;
based on the determination that the data corresponding to the plurality of regions correspond to the fault flag, obtain the remap address by applying a majority voting manner to data corresponding to the plurality of regions of the fault block from among the data corresponding to the target address; and
generate the second request including the obtained remap address.

19. A memory module comprising:
a memory device including a first fault block, a second fault block, a first remap block corresponding to the first fault block, and a second remap block corresponding to the second fault block; and
a controller including a cache memory, and configured to communicate with a host device through a compute express link (CXL) interface and control the memory device,
wherein the controller is configured to:
store mapping information, including a first fault address corresponding to the first fault block and a first remap address corresponding to the first remap block, in the cache memory;
redundantly store recovery information including a fault flag and a second remap address corresponding to the second remap block in the memory device based on a second fault address corresponding to the second fault block; and
based on receiving a first request including the first fault address from the host device, generate a second request including the first remap address based on the mapping information stored in the cache memory.

20. The memory module of claim 19, wherein the controller is configured to:
based on receiving a third request including the second fault address from the host device, read data corresponding to the second fault address from the memory device;
obtain the second remap address from the data corresponding to the second fault address through a majority voting manner; and
generate a fourth request including the obtained second remap address.
